(19) United States
(12) Patent Application Publication
(10) Pub. No.: US 2021/0252480 A1
(43) Pub. Date: Aug. 19, 2021

(54) Micro Circulatory Gas Chromatography System and Method

(71) Applicant: University of Utah Research Foundation, Salt Lake City, UT (US)

(72) Inventors: Hanseup Kim, Salt Lake City, UT (US); Hao-Chieh Hsieh, Salt Lake City, UT (US)

(73) Assignee: University of Utah Research Foundation

(21) Appl. No.: 17/308,822

(22) Filed: May 5, 2021

Related U.S. Application Data
(63) Continuation of application No. 15/439,772, filed on Feb. 22, 2017.
(60) Provisional application No. 62/298,055, filed on Feb. 22, 2016.

(51) Int. Cl. B01J 20/285; B01D 53/02; G01N 30/60; G01N 30/44; G01N 30/46

(52) U.S. Cl. CPC B01J 20/285; B01D 53/025; G01N 30/6095; G01N 2030/025; G01N 30/461; B01D 2253/202; G01N 30/44

(57) ABSTRACT

A gas chromatography system can include a circulatory loop, a gas inlet positioned along the circulatory loop, a gas outlet positioned along the circulatory loop, a micro column positioned in line with the circulatory loop, and an in-line population sensor positioned in line with the circulatory loop. The in-line population sensor can be configured to detect changes in gas population. The gas inlet and gas outlet can be associated with a gas inlet valve and gas outlet valve, and configured to admit or withdraw gas from the circulatory loop, respectively. A gas sample can be circulated through the circulatory loop for at least one cycle, and a component of the gas sample can be detected using the in-line population sensor.

### RELATED APPLICATION

This application is a continuation application of U.S. application Ser. No. 15/439,772, filed Feb. 22, 2017, which claims the benefit of U.S. Provisional Application No. 62/298,055 filed on Feb. 22, 2016, which are each incorporated herein by reference.

### GOVERNMENT INTEREST

This invention was made with government support under grant no. N66001-11-1-4149 awarded by the Navy/ONR. The government has certain rights in this invention.

### BACKGROUND

Among various chemical analysis instruments, the gas chromatograph (GC) has been regarded as a particularly effective tool because of its wide detection range of gas species. One advantage of GC is its capability to separate and detect multiple gaseous compounds in a single analysis by incorporating chromatographic separation of gas species before identification. This allows for detecting a broad range of gas species, where other instruments can only detect a few gas species. Chromatographic separation uses a chromatographic separation column, optionally coated with a stationary phase, in which various gas species travel along a column path until the gas species are separated from each other. The separation can be based on their affinity for the stationary phase coating and/or diffusion rates along the column path and is dependent on the chromatographic separation column's length. Generally, GC systems that have a longer separation column have a higher capacity and better separation of the gas sample. The separated species can then be detected by a gas sensor located at the end of the separation column and identified electronically by comparison to reference standards.

### SUMMARY

In one embodiment presented herein, a gas chromatography system can include a circulatory loop, a gas inlet positioned along the circulatory loop, a gas inlet valve, a gas outlet positioned along the circulatory loop, a gas outlet valve, a micro column positioned in line with the circulatory loop, and an in-line population sensor positioned in line with the circulatory loop. The gas inlet can be configured to admit gas into the circulatory loop and can be associated with the gas inlet valve. The gas outlet can be configured to withdraw gas from the circulatory loop and can be associated with the gas outlet valve. The in-line population sensor can be configured to detect changes in gas population. Optionally, multiple micro columns and in-line population sensors can be included in line with the circulatory loop.

In another embodiment, the gas chromatography system can include an in-line micro pump configured to circulate gas in the circulatory loop.

In yet another embodiment, the gas chromatography system can further include at least one additional gas inlet associated with a gas inlet valve and at least one additional gas outlet associated with a gas outlet valve. Similarly, the gas chromatograph system can also include at least one in-line blocking valve and a controller. The controller can be configured to open and close the gas inlet valve, the gas outlet valve, and the in-line blocking valve in a sequence to circulate gas in the circulatory loop as more fully described below.

In a further example, the gas chromatography system can include two gas inlets, two gas outlets, two in-line blocking valves, and two micro columns positioned along the circulatory loop in the order of: gas inlet; in-line blocking valve; gas outlet; micro column; gas inlet; in-line blocking valve; gas outlet; micro column.

In yet another example, the gas chromatography system can include the in-line population sensor positioned immediately before or immediately after each of the micro columns.

In one example, the gas chromatography system can include a controller in communication with the in-line population sensor and the gas outlet valve. The controller can be configured to open the gas outlet valve to withdraw materials associated with a detected peak from the circulatory loop to prevent overrun or cross-running of some samples. The controller can also be configured to extend the circulation of some materials associated with one or more detected peaks to magnify their separation as needed.

In yet another example, the gas chromatography system can include the micro column having a column length of at least 20 cm occupying an area of 2 cm² or less.

In another example, the in-line population sensor can be a thermal conductivity sensor, an optical sensor, or an electrochemical sensor. One example, of an optical sensor can be a Fabry-Perot sensor.

In yet another example of the gas chromatograph system, the in-line population sensor can be a thermal conductivity sensor. In one detailed example, the thermal conductivity sensor can have a suspended coil shape. Size ranges of the coil shape may vary and in one example the suspended coil shape can have a diameter of from about 450 μm to about 515 μm and a height ranging from about 525 μm to about 575 μm. In another example the thermal conductivity sensor can be formed of a wire having a thickness ranging from 1 μm to 10 μm.

In a further example of the gas chromatograph system, the thermal conductivity sensor can include a suspended sensing element, electric contact pads, a fluidic connection port, and a fluidic chamber lid. The suspended sensing element can be connected at one end to an electric contact pad and connected at another end to a second electric contact pad. One fluidic connection port can be placed over the electric contact pad and a second fluidic connection port can be placed over the second electric contact pad. A fluidic chamber lid can be oriented adjacent each of the fluidic connection ports and can enclose the suspended sensing element.

In one example of the gas chromatograph system, the in-line population sensor can be located at an inlet of the micro column and a second in-line population sensor can be located at an outlet of the micro column.

In another example, the in-line population sensor can be operable to send feedback signals to a sensor-feedback control program operable to control fluidic flow rates and monitor separation progress.

In yet another example the gas chromatograph system can further include a valve switching control unit in operative communication with at least one of the gas inlet valve, the gas outlet valve, and in-line blocking valve, when the system further comprises the in-line blocking valve. In one example, the valve switching control unit can be operable to coordinate an opening and a closing of at least one of the gas inlet valve, the gas outlet valve, and the in-line blocking valve.

In a further example of the gas chromatography system, the micro column can include a separation enhancing coating on an interior surface of the micro column.

Further presented herein is a method of separating gas samples through gas chromatography. In one embodiment, a method of separating a gas sample through gas chromatography can include admitting a gas sample into a circulatory loop of a gas chromatography system, circulating the gas sample through the circulatory loop for at least one cycle, and detecting at least one component of the gas sample using an in-line population sensor. The gas chromatography system used in the method can include the circulatory loop, a gas inlet positioned along the circulatory loop, a gas inlet valve, a gas outlet positioned along the circulatory loop, a gas outlet valve, a micro column positioned in line with the circulatory loop, and the in-line population sensor positioned in line with the circulatory loop. The gas inlet can be configured to admit gas into the circulatory loop and can be associated with the gas inlet valve. The gas outlet can be configured to withdraw gas from the circulatory loop and can be associated with the gas outlet valve. The in-line population sensor can be configured to detect changes in gas population.

In one example, the circulating can be performed using an in-line micro pump.

In another example, the gas chromatography system used in the method can include an in-line blocking valve. Circulating the gas sample can be performed by opening and closing the gas inlet valve, the gas outlet valve, and the in-line blocking valve in a sequence to circulate the gas in the circulatory loop.

In yet another example, the system used in the method of separating gas can include two gas inlets, two gas outlets, two in-line blocking valves, and two micro columns positioned along the circulatory loop in the order of: gas inlet; in-line blocking valve; gas outlet; micro column; gas inlet; in-line blocking valve; gas outlet; micro column. In a further example, the gas chromatography system used in the method of separating gas can include an in-line population sensor positioned immediately before or immediately after each micro column.

In one example, the method of separating a gas sample can further include opening the gas outlet valve to withdraw materials associated with a detected peak from the circulatory loop to prevent overrun.

In another example, the method of separating a gas sample can further include opening the gas outlet valve to withdraw a separated component of the gas while allowing remaining undifferentiated components to continue circulating.

In a further example, the method of separating a gas sample can further include opening the gas outlet valve to withdraw undifferentiated components from the circulatory loop and admitting the undifferentiated components into a second gas chromatography system for further separation.

In yet another example, a separation enhancing coating on an interior surface of the micro column in the gas chromatography system and a separating enhancing coating on an interior surface of a second micro column in the second gas chromatography system are different.

In a further example, the method of separating a gas sample can further include opening the gas outlet valve to withdraw one or more components of the gas and analyzing the one or more components using a mass spectrometer.

In yet another example of the gas chromatography system used in the method of separating a gas sample the in-line population sensor can be a thermal conductivity sensor and the detecting can be performed by measuring a change in thermal conductivity of the gas in the circulatory loop.

In one example, the method of separating a gas sample, can further comprise monitoring separation progress as detected by the in-line population sensor.

With the general examples set forth in the Summary above, it is noted when describing the system or method, individual or separate descriptions are considered applicable to one other, whether or not explicitly discussed in the context of a particular example or embodiment. For example, in discussing a device per se, other device, system, and/or method embodiments are also included in such discussions, and vice versa.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1 is a schematic illustration of a gas chromatography system in accordance with an embodiment of the present technology.

FIG. 2 schematically illustrates the timing of opening and closing valves during a cycle in accordance with an embodiment of the present technology.

FIG. 3 graphically illustrates the separation of pentane and decane with small peaks forming due to valve switching noise in accordance with an embodiment of the present technology.

FIG. 4 is a schematic illustration of a gas chromatography system in accordance with an embodiment of the present technology.

FIG. 5 is a schematic illustration of a micro column in accordance with an embodiment of the present technology.

FIG. 6 is an image of a micro column in accordance with an embodiment of the present technology.

FIG. 7 is a schematic illustration of a micro column in accordance with an embodiment of the present technology.

FIG. 8 is a graph of separation efficiency of micro columns at different flow rates and stationary phase thicknesses.

FIG. 9A is a graph illustrating the separation of gas peaks over the length of a conventional chromatography column.

FIG. 9B is a graph illustrating the separation of gas peaks over multiple cycles of a circulatory gas chromatography system in accordance with an embodiment of the present technology.

FIG. 10A is an image of a thermal conductivity sensor in a suspended coil shape, in accordance with an embodiment of the present technology.

FIG. 10B is a graph illustrating voltage and power requirements for several different wire thicknesses.

FIG. 11 is a schematic illustration of a thermal conductivity sensor in accordance with an embodiment of the present technology.

FIG. 12 is a graph illustrating the effect of multiple cycles of a circulatory gas chromatography system on signal intensity in accordance with an embodiment of the present technology.

FIG. 13 is a schematic illustration of the steps in a process of fabricating a micro column in accordance with an embodiment of the present technology.

FIG. 14A is an image of a silicon wafer having multiple micro columns formed therein in accordance with an embodiment of the present technology.

FIG. 14B is an image of a silicon wafer having multiple micro columns formed therein in accordance with an embodiment of the present technology.

FIG. 15 is a graph illustrating separation of a pentane and hexane mixture over 6 cycles in circulatory gas chromatography system in accordance with an embodiment of the present technology.

FIG. 16 is a schematic illustration of the steps in a process of fabricating a thermal conductivity sensor in accordance with an embodiment of the present technology.

FIG. 17 is a schematic illustration of the steps in a process of fabricating a thermal conductivity sensor have a fluidic chamber lid in accordance with an embodiment of the present technology.

FIG. 18 is a schematic illustration of the steps in a process of fabricating micro column incorporating an in-line population sensor at an inlet and at an outlet of the micro column in accordance with an embodiment of the present technology.

FIG. 19 is a schematic illustration of the measurements taken by an in-line population sensor at an inlet and at an outlet of a micro column in accordance with an embodiment of the present technology.

FIG. 20A is an image of a micro column incorporating an in-line population sensor at an inlet and at an outlet of the micro column in accordance with an embodiment of the present technology.

FIG. 20B is an image of a micro column incorporating an in-line population sensor at an inlet and at an outlet of the micro column in accordance with an embodiment of the present technology.

FIG. 20C is an image of a micro column incorporating an in-line population sensor at an inlet and at an outlet of the micro column in accordance with an embodiment of the present technology.

These drawings are provided to illustrate various aspects of the invention and are not intended to be limiting of the scope in terms of dimensions, materials, configurations, arrangements or proportions unless otherwise limited by the claims.

### DETAILED DESCRIPTION

While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

The following embodiments are set forth without any loss of generality to, and without imposing limitations upon, any claims set forth. It is also to be understood that the terminology used herein is for the purpose of describing particular embodiments only, and is not intended to be limiting. Unless defined otherwise, all technical and scientific terms used herein have the same meaning as commonly understood by one of ordinary skill in the art to which this disclosure belongs.

It is noted that, as used in this specification and in the appended claims, the singular forms “a,” “an,” and “the” include plural referents unless the context clearly dictates otherwise. Thus, for example, reference to “an inlet” includes one or more of such features, reference to “a valve” includes reference to one or more of such elements, and reference to “circulating” includes reference to one or more of such steps.

As used herein, the terms “about” and “approximately” are used to provide flexibility, such as to indicate, for example, that a given value in a numerical range endpoint may be “a little above” or “a little below” the endpoint. The degree of flexibility for a particular variable can be readily determined by one skilled in the art based on the context.

As used herein, “comprises,” “comprising,” “containing” and “having” and the like can have the meaning ascribed to them in U.S. Patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that, which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the compositions nature or characteristics would be permissible if present under the “consisting essentially of” language, even though not expressly recited in a list of items following such terminology. When using an open ended term in this specification, like “comprising” or “including,” it is understood that direct support should be afforded also to “consisting essentially of” language as well as “consisting of” language as if stated explicitly and vice versa.

As used herein, comparative terms such as “increased,” “decreased,” “better,” “higher,” “lower,” and the like refer to a property of a device or component, that is measurably different from other devices or components, in a surrounding or adjacent area, in a single device or in multiple comparable devices, in a group or class, in multiple groups or classes, or as compared to the known state of the art. This applies both to the form and function of individual components in a device or process, as well as to such devices or processes as a whole.

As used herein, the term “substantially” refers to the complete or nearly complete extent or degree of an action, characteristic, property, state, structure, item, or result. The exact allowable degree of deviation from absolute completeness may in some cases depend on the specific context. However, the nearness of completion will generally be so as to have the same overall result as if absolute and total completion were obtained. The use of “substantially” is equally applicable when used in a negative connotation to refer to the complete or near complete lack of an action, characteristic, property, state, structure, item, or result.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context. In certain cases, two elements that are “adjacent” along a circulatory loop can be neighboring elements without any other elements between the adjacent elements other than a gas line connecting the adjacent elements in the circulatory loop.

As used herein, the term “about” is used to provide flexibility to a numerical range endpoint by providing that a given value may be “a little above” or “a little below” the endpoint. However, it is to be understood that even when the term “about” is used in the present specification in connection with a specific numerical value, that support for the exact numerical value recited apart from the “about” terminology is also provided.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of about 1 to about 4.5 should be interpreted to include not only the explicitly recited limits of 1 to about 4.5, but also to include individual numerals such as 2, 3, 4, and sub-ranges such as 1 to 3, 2 to 4, etc. The same principle applies to ranges reciting only one numerical value, such as “less than about 4.5,” which should be interpreted to include all of the above-recited values and ranges. Further, such an interpretation should apply regardless of the breadth of the range or the characteristic being described.

Reference throughout this specification to “an example” means that a particular feature, structure, or characteristic described in connection with the example is included in at least one embodiment. Thus, appearances of the phrases “in an example” in various places throughout this specification are not necessarily all referring to the same embodiment.

Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein.

Accordingly, the scope of the invention should be determined solely by the appended claims and their legal equivalents, rather than by the descriptions and examples given herein. Reference will now be made to the exemplary embodiments illustrated, and specific language will be used herein to describe the same. It will nevertheless be understood that no limitation of the scope of the technology is thereby intended. Additional features and advantages of the technology will be apparent from the detailed description which follows, taken in conjunction with the accompanying drawings, which together illustrate, by way of example, features of the technology.

Furthermore, various modifications and combinations can be derived from the present disclosure and illustrations, and as such, the following figures should not be considered limiting.

The present technology provides micro circulatory gas chromatography systems and methods. These micro circulatory systems can be made small enough for personal-level monitoring. Personal-level monitoring requires a small volume gas chromatograph system that is easily portable. For example, one application of the systems can include personal air quality monitors for measuring air pollution levels at the location of a user. These micro circulatory systems also overcome several problems that have been encountered in the miniaturization of GC technology.

Conventional GC systems have not been suitable for field analysis or personal-level monitoring because conventional GC systems typically include bulky separation columns in order to allow for separation of the sample. Long separation columns are able to isolate targets farther apart and allow for more targets to be distinguished. Miniaturizing the components of a conventional GC system can result in reduction of detection range of the system because the separation column length is reduced. Reduced column length results in a lower detection capacity because gas species have limited time to fully separate. In addition, long column lengths have not been suitable in miniaturized GC systems due to limitations of current micro pump technology. Longer columns require higher pumping pressure in order for the gas to flow at the optimal flow rate along the entire length of the column. Currently available micro pumps are also not capable of providing sufficient pressure for longer separation columns.

The present technology achieves the advantages of GC systems having long separation columns without requiring higher pressures than can be provided by currently available micro pumps. This is accomplished by using a circulatory loop with one or more micro columns along the loop. The actual length of the micro columns can be sufficiently short so that gas can be pumped through the micro columns using micro pumps, while the effective column length in the system can be extended by recirculating the gas around the circulatory loop multiple times. Thus, each cycle through the micro column can further separate a sample into multiple gas species as if the length of the micro column were extending. The recirculating loop creates an effective column length that is much greater than the length of the micro column and the actual loop circumference. The effective column length is only limited by the number of passes about the circulatory loop.

The GC systems presented herein can be micro sized. The micro columns and other components can be formed on one or more chips using MEMS (microelectromechanical systems) technology. Thus, the system can be small enough to use as a portable GC for field work, a personal air quality monitoring device, and in other applications. Despite the small size of the system, the effective column length of the system, and therefore its detection capacity, can be comparable to conventional GC systems.

With the above description in mind, the present technology provides gas chromatography systems and methods of separating a gas sample through gas chromatography. In some examples, a gas chromatography system can include a circular loop with a gas inlet, a gas inlet valve, a gas outlet, a gas outlet valve, a micro column, and an in-line population sensor. The gas inlet, the gas outlet, the micro column, and the in-line population sensor can be positioned along or in line with the circulatory loop. The gas inlet can be associated with the gas inlet valve and configured to admit gas into the circulatory loop. Similarly, the gas outlet can be associated with the gas outlet valve and configured to withdraw gas from the circulatory loop. The in-line population sensor can be configured to detect changes in a gas population.

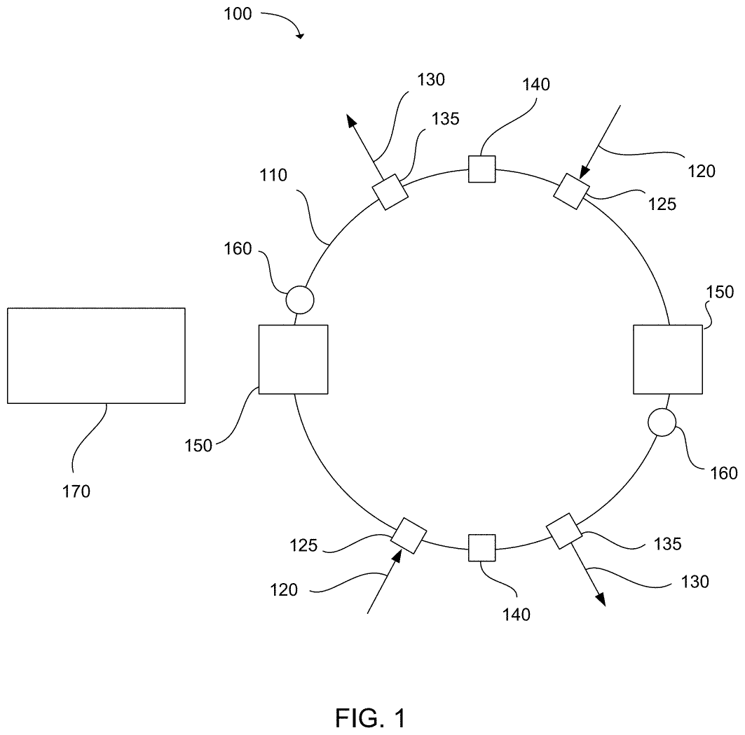

FIG. 1 shows an example of a gas chromatography system 100 in accordance with an embodiment of the present technology. In this particular embodiment, the system includes a circulatory loop 110 with two gas inlets 120, two gas outlets 130, two in-line blocking valves 140, two micro columns 150, and two in-line population sensors 160 positioned along the circulatory loop. The gas inlets and the gas outlets are associated respectively with gas inlet valves 125 and gas outlet valves 135. The valves can be switched either to allow gas to flow in or out of the circulatory loop through the gas inlets and the gas outlets, or to direct the gas to circulate within the circulatory loop. The system shown in FIG. 1 also includes a controller 170 that can communicate by wired or wireless connection with the gas inlet valve, the gas outlet valve, and/or the in-line population sensors.

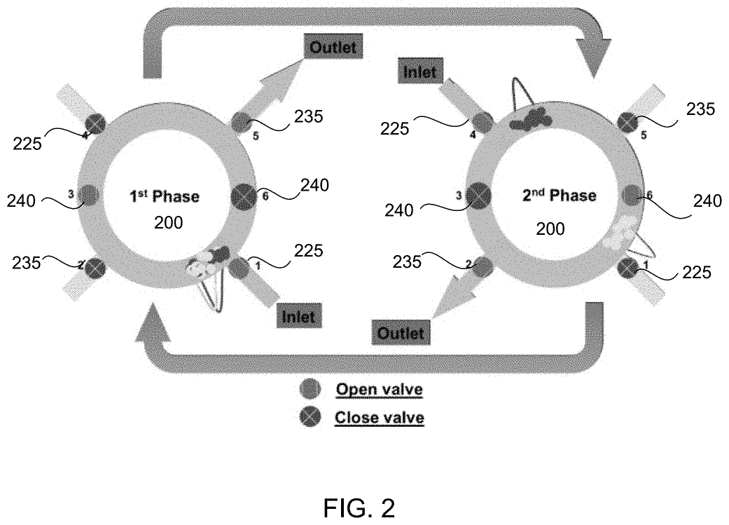

The exemplary gas chromatography system shown in FIG. 1 can circulate gas around the circulatory loop without the use of a micro pump by timing the opening and closing of the gas inlet valves and gas outlet valves to add and withdraw carrier gas in such a way that the gas species being analyzed are pushed around the loop. The timing of the opening and closing can be manually determined and adjusted or can be automatic by incorporating programmable micro circuitry into the system. The timing of opening and closing of a gas inlet valve and a gas outlet valve can be in cycles. For example, FIG. 2 illustrates a two-phase method of circulating gas (gas movement shown by the arrow) in a circulatory loop 200 by timing an opening and a closing of the gas inlet valve 225 and the gas outlet valve 235. In the first phase, one set of the gas inlet valve, the gas outlet valve, and the in-line blocking valve 240 are opened (valves 1, 3, and 5 in the figure) while the other set of valves are closed to allow carrier gas to flow through the loop. This allows the gas sample to move around the loop. Before the gas sample reaches the open outlet valve (5 on the first ½ cycle), the valves are switched so that the opposite set of valves are opened (valves 2, 4, and 6 in the figure, shown open in the adjacent second ½ cycle). This allows the gas sample to continue travelling around the circulatory loop. These two cycles can be repeated as many times as necessary to separate the gas sample into individual gas species. Thus, the effective column length of the system is the total distance travelled by the gas sample as it moves around the circulatory loop and is eventually removed via a corresponding outlet.

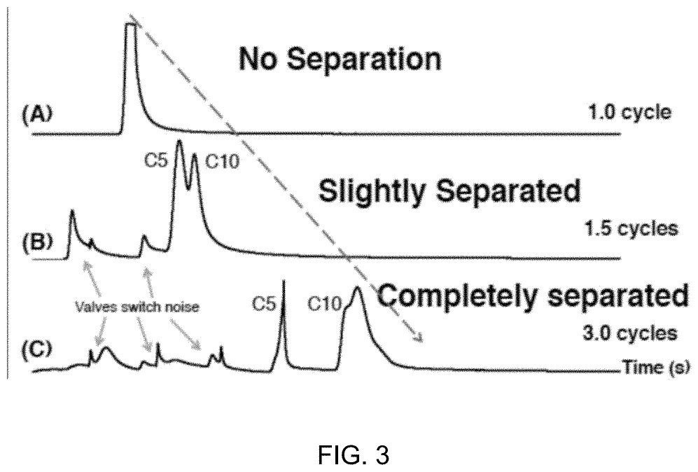

In some cases, using multiple inlet gas valves and outlet gas valves to control the movement of a gas sample around the circulatory loop can provided a higher separation capacity than the separation capacity provided by an in-line micro pump. Some micro pumps can add turbulence to the gas in the circulatory loop, thus mixing the gas species and interfering with the separation of the gas species. Using multiple inlet valves and outlet valves together with in-line blocking valves, as shown in FIG. 1 and FIG. 2, can allow the gas sample to move around the circulatory loop with little turbulence. However, in some cases, switching gas inlet valves, gas outlet valves, and in-line blocking valves open and closed can introduce a small amount of noise into the gas sample. This noise generally appears as small peaks. FIG. 3 shows an exemplary graph of the separation of pentane and decane, with small peaks forming due to valve switching noise and illustrates the increase in separation distance of the pentane (C5) and the decane (C10) over three cycles. Valve switching noise can usually be distinguished from the sample peaks based on the small peak size. The movement speed of the gas sample around the circulatory loop can also be controlled using gas inlet valves. In one example, this can be controlled by the flow rate of carrier gas admitted through the gas inlet valves.

Although FIG. 1 shows an embodiment with two gas inlet valves, two gas outlet valves, and two in-line blocking valves, other numbers and arrangement of gas inlet valves, gas outlet valves, and in-line blocking valves can effectively move the gas sample around the circulatory loop. For example, some embodiments can include 1, 2, 3, 4, or more each of gas inlet valves, gas outlet valves, and in-line blocking valves.

In some examples, the gas chromatography system can include an in-line micro pump on the circulatory loop that can be used to circulate gas in the circulatory loop. The in-line micro pump can create a sufficiently small amount of turbulence in the gas that the system is still able to effectively separate the gas species. Such a micro pump can be used to continuously circulate the gas sample around the circulatory loop without requiring the multi-phase switching of gas inlet valve, gas outlet valve, and in-line blocking valves as described above. FIG. 4 illustrates an exemplary embodiment of a gas chromatography system 400 including a circulatory loop 410, a gas inlet 420, gas inlet valve 425, gas outlet 430, gas outlet valve 435, in-line micro pump 480, micro column 450, in-line population sensor 460, and controller 470. In this embodiment the gas inlet can be used at the beginning of the analysis of a gas sample for filling the circulatory loop with carrier gas and injecting the gas sample into the circulatory loop. After the gas sample is injected, the gas inlet can be closed and the in-line micro pump can be used to circulate the gas sample around the circulatory loop. The gas outlet can be used during and/or after the cycling to flush separated species and/or all of gas from the system. Additionally, in some examples the gas outlet can be used to flush a portion of the gas sample during the separation.

Although the embodiments in FIG. 1 and FIG. 4 are shown with a circulatory loop having a circular shape, these figures are merely schematics and should not be considered limiting. Any shaped loop that allows for continual cycling of the sample can be used (e.g. elliptical, serpentine, figure eight-shaped, and the like). The gas chromatography system can have a variety of shapes, sizes, and arrangements. For example, in one GC system, the circulatory loop can include components arranged in the order of a gas inlet, gas inlet valve, in-line blocking valve, gas outlet, gas outlet valve, micro column, gas inlet, gas inlet valve, in line blocking valve, gas outlet, gas outlet valve, and micro column.

The micro columns in the gas chromatography systems according to the present technology can provide a significant separation column length while occupying a small volume. The volume occupied by the micro columns can be significantly less than the volume occupied by conventional gas chromatography columns which can range from 5 to 100 meters. In some examples, the micro column can have a column length of at least 20 cm and can occupy an area of 2 cm² or less. In another example, a micro column can have a column length of at least 25 cm while occupying an area of 2 cm² or less.

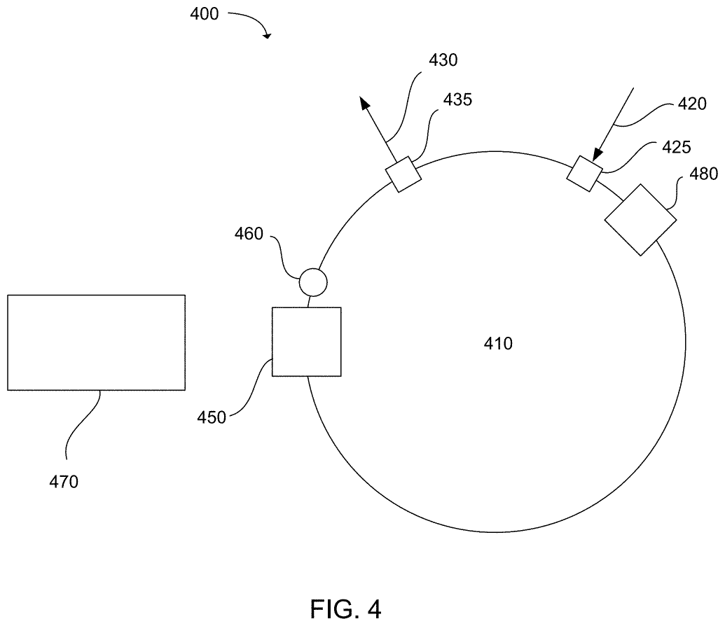

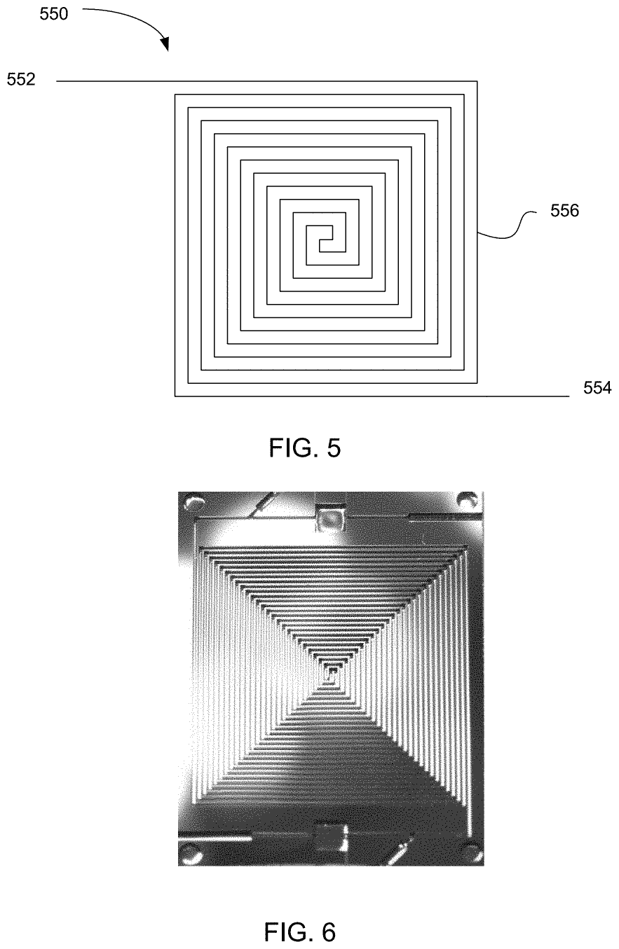

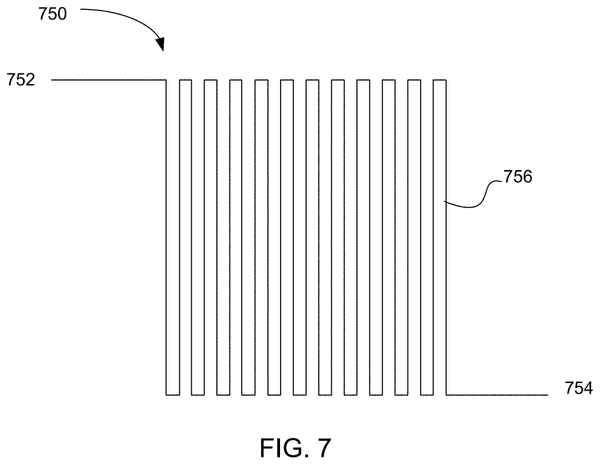

In order to achieve these long column length in a small area, a micro column can include a gas pathway with multiple turns that allow the column to fold back and forth in a small area. For example, FIG. 5 illustrates one example of a micro column 550 having an inlet 552, an outlet 554, and a pathway 556 in the shape of a double spiral. Gas can enter the micro column through an inlet on one side of the micro column, travel through the double spiral-shaped pathway and exit through an outlet on the other side of the micro column. A SEM image of a similar micro column is shown in FIG. 6. The well shown in the top center of the image is a cavity in which an in-line population sensor can be formed. Other configurations of micro column pathways can also be used. For example, FIG. 7 shows a micro column 750 having an inlet 752, an outlet 754, and a pathway 756 in a serpentine-shape. These gas pathways can provide a significant column length for separation while keeping the volume of the overall micro column small.

In some examples, micro columns can be fabricated by forming a micro channel in a substrate. For example, a micro column can be formed into the surface of a substrate such as a silicon wafer. The micro channel can follow a two-dimensional pathway, such as the double spiral and serpentine pathways described above. The substrate can include a variety of materials, including, for example, a silicon wafer, an acryl sheet, a glass wafer, and various organic and inorganic substrates.

In some examples, a micro column can include a separation enhancing coating on an interior surface of the micro column. The coating is referred to as a “stationary phase.” The stationary phase coating can include known stationary phase coating and can vary depending on the types of gas samples being separated. Any stationary phase material that has different retention rates for different components of the gas sample can effectively separate the components of the gas sample. For example, the stationary phase coating can be OV-1, OV-5 ms, OV-35, or customized material, like packed nanoparticle, etc. In one example, the stationary phase can be a polar polymer, or a nonpolar polymer. In a specific example, the stationary phase coating can be OV-1. OV-1 is a nonpolar polymer that can aid in separation of hydrocarbons. In some examples, a relatively thin coating of a stationary phase material can be used, having a thickness such as about 0.1 μm to about 5 about 0.5 μm to about or about 1 μm to about 3 μm.

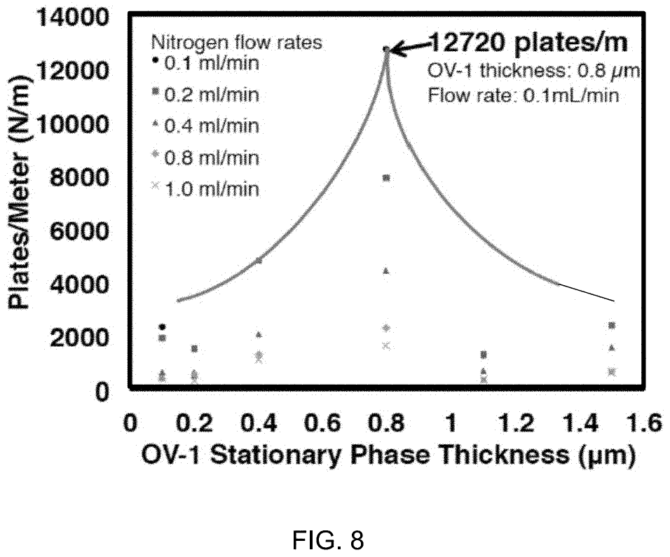

FIG. 8 shows a graph of separation efficiency of micro columns at different flow rates and stationary phase thicknesses. The graph of separation efficiency shows that the maximum efficiency was found to be at a stationary phase thickness of 0.8 and a flow rate of 0.1 mL/min. In various embodiments of the present technology, the optimal stationary phase thickness and flow rate can vary depending on the geometry of the micro column, the type of stationary phase, the type of gas sample being separated, and other factors. in one example, the cross section of the micro column can have channels with dimensions ranging from about 100 μm to about 400 μm. In another example, the cross section of the micro column can be about 150 μm by 372 μm. The layer of OV-1 stationary phase on the insides of the channel walls can be, in one example, about 1.03 μm in thickness.

Pressures required to pump gas through the micro columns can be low enough for currently available micro pumps to meet the pumping pressure requirements. In one example, the pressure required to pump gas through the micro column can be less than 10 kPa. In another example, the pressure required to pump gas through the micro column can be less than 7 kPa, and in one case is about 5.5 kPa with two 25 cm micro columns. In some examples, the micro column can have a pressure drop of 1-15 kPa from the micro column inlet to the micro column outlet, considering currently available micro pump technology. In some examples, pressurized carrier gas can be supplied to the circulatory loop through the gas inlet and can become pressurized by an external micro pump.

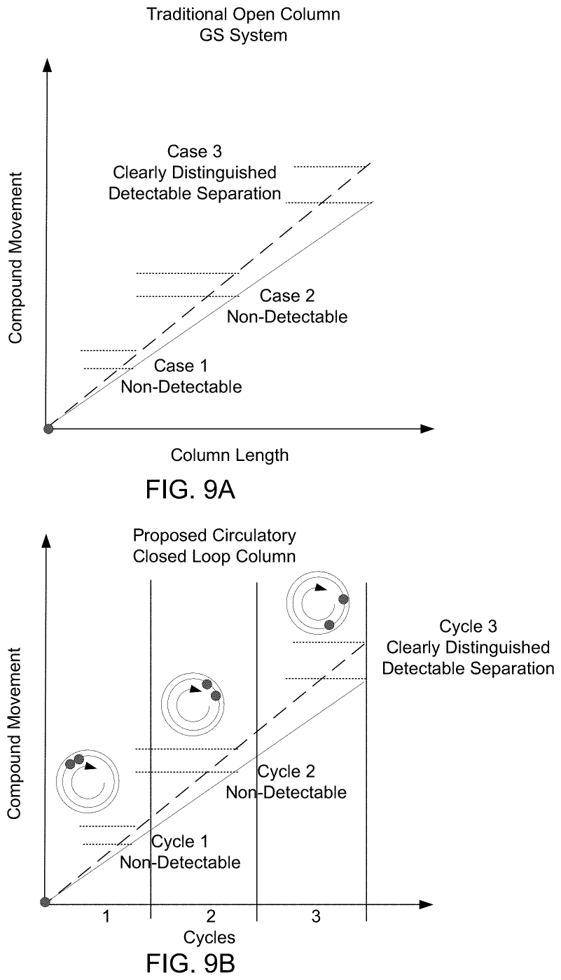

FIGS. 9A and 9B illustrate a comparison between separation of gas peaks over the length of a conventional gas chromatography column (FIG. 9A) and separation of gas peaks over multiple cycles of a circulatory gas chromatography system as presented herein (FIG. 9B). As shown in these figures, similar separation can be achieved using multiple cycles through a short circulatory loop to the separation acquired by a longer conventional column. In addition, since the actual length of the circulatory loop is short, the pressure required to pump the gas through the loop is less than the pressure required to pump gas through the longer conventional gas chromatography column.

The gas chromatography systems presented herein, can further include an in-line population sensor which can help to determine the number of cycles needed to achieve discernible separation. In certain embodiments an in-line population sensor can be placed on the circulatory loop before or after each micro column. As shown in FIG. 1, in some cases the in-line population sensors 160 can be placed after each micro column 150, between the micro columns 150 and the gas outlets 135. In this configuration, the population sensors can be used to sense peaks before the peaks pass the gas outlet. In another example, the gas chromatography system can include two in-line population sensors associated with the micro columns. For example, one in-line population sensor can be located an inlet of the micro column and a second in-line population sensor can be located at an outlet of the micro column. The placement of the in-line population sensors at the entry and exit points of a micro column can allow for monitoring of gas samples and the separation distance between differentiated and undifferentiated components.

The in-line population sensors can be any type of sensor that can differentiate between various gas components flowing through the circulatory loop. In one example, the in-line population sensor can be a thermal conductivity sensor, an optical sensor, or an electrochemical sensor. In another example, the in-line population sensor can be a thermal conductivity sensor. The thermal conductivity sensor can be initially heated to a fixed temperature via electronic controller. At the set fixed temperature, the resistance value remains identical and a change in electrical resistance value can occur, as temperature decreases with energy loss (heat flux) are extracted as flowing gaseous materials pass by the sensor. Higher concentrations of gaseous molecules under identical flow rates will cause a larger temperature drop, and thus a larger resistance change. Various types of gaseous molecules would cause different rates of temperature drops as well as resistance changes. The resistance changes can be positive or negative depending on the material types of the thermal conductivity sensors.

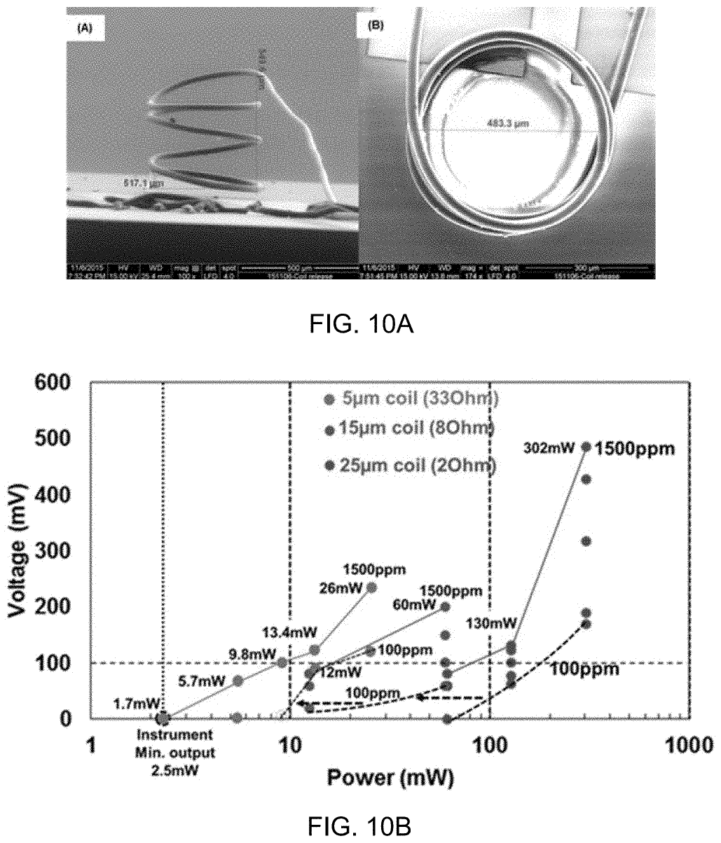

In yet another example, the thermal conductivity sensor can have a suspended coil shape, as shown in FIG. 10A. The coil shape can be formed of a wire having a thickness ranging from about 1 μm to about 25 μm, such as about 1 μm to about 10 μm, about 2 μm to about 8 μm, or about 5 μm. The coil can have a diameter ranging from about 150 μm to about 700 μm and a height ranging from about 50 μm to about 550 μm. In one example, the coil can have a diameter of about 483 μm and a height of about 549 μm. The wire thickness and size can influence the power requirements as illustrated generally by FIG. 10B. In one example, a wire having a thickness of 25 μm can have a power consumption of 60 mW and can detect pentane gas down to 100 ppm per FIG. 10B. In another example, a wire having a thickness of 5 μm can have a power consumption of 13.4 mW and can detect pentane gas down to 100 ppm. Digital filtering can also be used during measurement to further decrease the detection limit. For example, a preliminary measurement result showed the limit of detection was 326 ppb when using digital filter during measurement for the above example parameters.

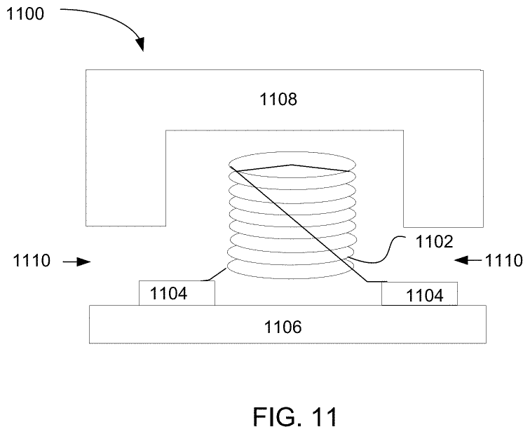

In some examples, the coil can be suspended in air with one end of the wire forming the coil connected to an electrode contact and the other end of the wire forming the coil connected to a second electrode contact. In some examples the electrode contact pads can be located on a support structure. In further examples, the thermal conductivity sensor can further comprises a fluidic chamber lid and fluidic connection ports. An exemplary thermal conductivity sensor 1100, is illustrated in FIG. 11, can have a coil 1102, with electrode contacts 1104, support structure 1106, fluidic chamber lid 1108, and fluidic connection ports 1110. In one example, the thermal conductivity can include a suspended sensing element oriented within a fluidic chamber having a fluid inlet and a fluid outlet where the sensing element includes electrode contact pads and a suspended wire coil. The thermal conductivity sensor can further include a fluidic chamber lid. In some examples, a digital filter can be used in combination with the in-line population sensor.

In some examples, the in-line population sensor can be operable to send feedback signals to a sensor-feedback control program that is operable to control fluidic flows, valve actuation, and/or monitor separation progress.

In one example, the GC system can further include a controller. The controller can be configured to switch at least one of the gas inlet valve, the gas outlet valve, and the in-line breaking valve in the system before the gas peaks reach the outlet so that the gas peaks can continue to circulate. In some examples, the controller can be in communication with the in-line population sensor and the gas outlet valve. This can allow the system to purge gas peaks that have fully separated and have been measured. If the in-line population sensor senses that a gas peak has become fully separated, then the controller can keep the gas outlet and associated gas outlet valve open long enough for the separated peak to be purged out of the circulatory loop. This can prevent overrun and enable magnification of the undifferentiated portion of the sample. Gas overrun can occur when faster moving gas peaks move around the circulatory loop so quickly that the faster gas peaks catch up with slower moving gas peaks. At this point, if the circulation continues then the faster moving gas peaks can begin to mix with the slower moving gas peaks, which reduces the separation of the gas peaks. To avoid this, the in-line population sensors can be used to detect fast moving gas peaks that are approaching slow moving gas peaks in the circulatory loop. If a fast moving gas peak is about to overrun the slow moving gas peaks, then the gas outlet can be opened to purge the fast moving gas peak out of the circulatory loop. If the fast moving gas peak contains multiple components that have not fully separated at this point, then the fast moving gas peak can optionally be directed into a second circulatory gas chromatography system and separated further. Thus, all gas components in the gas sample can be separated while avoiding overrun.

In some examples, the GC systems presented herein can further include a valve switching control unit in communication with at least one of the gas inlet valve, gas outlet valve, and the in-line blocking valves. In one example, the communication can be wireless. The valve switching control unit can be operable to coordinate an opening and a closing of at least one of the gas inlet valve, the gas outlet valve, and the in-line blocking valve. The valve switching control unit can provide automated control of the valves when a separated peak baseline return to a signal baseline before the mixture peak or the separation resolution reaches at least Rs≈1.5. This automatic control avoids the labor associated with manually opening and closing the valves and can allow for more precise valve switching.

In some examples, the GC systems presented herein can further include programmable micro circuitry. In some examples, the programmable micro circuitry can be as described in the automated examples above. In another example, the in line population sensor can be configured to detect changes in gas population in situ and to send feedback signals to valves and/or pumps in order to control fluidic flows. In another example, the in-line population sensor can be configured to send real-time separation monitoring to an external computer. The real time separation monitoring can provide information with respect to sample separation in the circulatory loop without interrupting the flow in the loop and can avoid sample over run by eluting separated samples from the system. In some embodiments, multiple circulatory gas chromatography systems can be used together. In some examples, the multiple circulatory gas chromatography systems can incorporate different stationary phase materials. For example, a first circulatory gas chromatography system can include a polar stationary material while a second system can include a nonpolar stationary material. This can be particularly useful when some components of a gas sample do not separate well in the first system. In this instance, the unseparated components can be purged from the first system and directed into the second system where the components can separate more easily in a GC system that incorporates a second type of stationary phase material. In other examples, two or more circulatory gas chromatography systems can be used together, each having a different stationary phase material selected to separate one or more components of the gas sample.

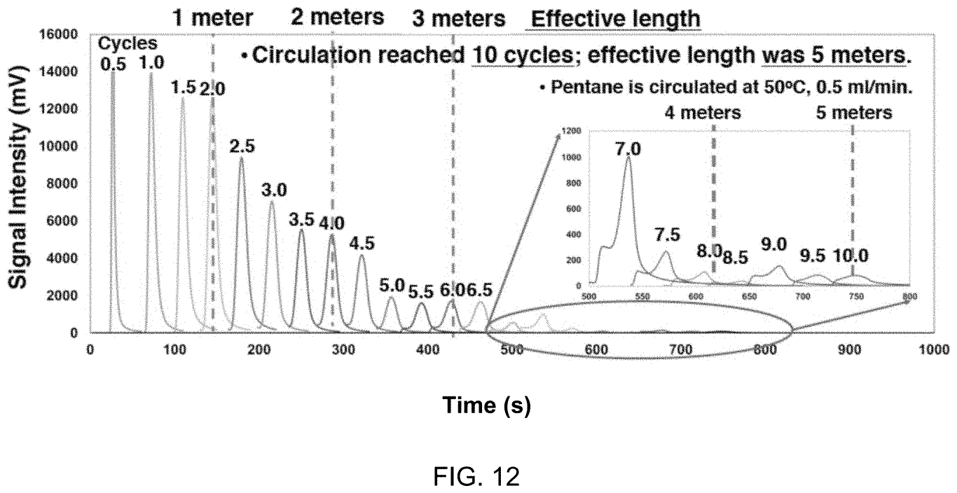

FIG. 12 is a graph illustrating the effect of multiple cycles of a circulatory gas chromatography system on signal intensity. As shown in the figure, signal intensity decreases with more cycles through the circulatory loop. In some embodiments, the number of cycles used can be sufficient to separate the components of the gas sample while also being small enough that the signal intensity is sufficient to measure the peaks. In various embodiments, the number of cycles used can be from 2 to 20, from 3 to 15, or from 3 to 10.

Further presented herein are methods for separating a gas sample which can include any of systems and elements described above. In one example, a method of separating a gas sample through gas chromatography can include admitting a gas sample into a circulatory loop of a gas chromatography system, circulating the gas sample through the circulatory loop for at least one cycle, and detecting at least one component of the gas sample using an in-line population sensor. The gas chromatography system can include the circulatory loop, a gas inlet, gas inlet valve, gas outlet, gas outlet valve, micro column, and the in-line population sensor. The gas inlet can be positioned along the circulatory loop, can be configured to admit gas into the circulatory loop, and can be associated with a gas inlet valve. The gas outlet can be positioned along the circulatory loop, can be configured to withdraw gas from the circulatory loop, and can be associated with a gas outlet valve. The micro column can be positioned in-line with the circulatory loop. The in-line population sensor can also be positioned in-line with the circulatory loop and can be configured to detect changes in gas population. The circulation of the gas through the circulatory loop can be accomplished using an in-line micro pump or by timing the gas inlet valve, the gas outlet valve, and the in-line blocking valve as described above. The timing can be determined manually or can be automatic when programmable micro circuitry is included in the system.

In some embodiments, the gas outlet can be used to withdraw one or more separated components from the circulatory loop while allowing undifferentiated components to continue circulating in the system. In other examples, the gas outlet valve can be used to withdraw undifferentiated components from the circulatory loop and the undifferentiated components can then be admitted into a second GC system. This can be useful for mixed samples that do not have the same affinity for the stationary phase. In one example, the second GC system can have a different separation enhancing (stationary phase) coating on an interior surface of the micro columns. In yet another example, the gas outlet can be used to withdraw one or more components from the system and then the components can be directed to a mass spectrometer for further analysis. In a further example, the method can include monitoring the separation progress as detected by the in line population sensor.

As previously mentioned, in some cases specific samples may include components which may overrun (move faster around the circulatory loop and eventually mix in with) slower components. The overrunning can be predicted by comparing the retention time of fastest samples and slowest samples. Retention time (t_{R}) can be defined as the time period needed for a sample to make one turn (complete one cycle) in the circulatory loop (length=L). If the retention time of each sample is t_{R1} and t_{R2}, the speeds of each sample are:

$${v}_{1} = \frac{L}{{t}_{R 1}} , {v}_{2} = \frac{L}{{t}_{R 2}}$$

Thus, the time it takes for the fastest sample to over-run the slowest sample can be calculated as:

$$overrun - time = \frac{L}{{v}_{1} - {v}_{2}} = \frac{{t}_{R 1} \cdot {t}_{R 2}}{{t}_{R 2} - {t}_{R 1}}$$

This ‘over-run’ time specifies how many turns the fastest sample can take without encountering the slowest sample and thus without losing the detection selectivity. The maximum allowable turns can be calculated as:

$$n = max . integer < \frac{overrun - time}{{t}_{R 1}} = \frac{{t}_{R 2}}{{t}_{R 2} - {t}_{R 1}}$$

Once the maximum allowable turns of the fastest samples is known, the limitation can be overcome by flushing some of the fastest samples out of the circulatory loop by appropriately controlling the microvalves as described previously. At the initial stage, target samples can be selected with a high retention time ratio (t_{R1} over t_{R2}) between the fastest and the slowest samples to ensure multiple circulation of the samples. For example, the retention time ratio of 97% would allow >33 turns of sample circulation. This calculation indicates that the system will be more beneficial in separating closely-located gaseous samples, which is opposite to typical gas chromatography systems.

Potential front-running samples that overrun the end-running samples in a short circulatory closed-loop path can be prevented by multiple order separation. The concept utilizes multiple sensors spread along the column that monitor in-situ locations of target samples and enable selective containing and flushing of target samples at each cycle. The conduits can be momentarily closed to prevent any unwanted sample movement during flushing. Clearly separated groups display distinct peaks at the sensor signal as they pass through the particular sensor located at one of the multiple sensor positions. On the other hand, undifferentiated sample groups, that are not fully separated yet, produce one broad peak in the sensor signals. In the contain-and-flush process, separated and detected groups can be flushed out, while mixed groups can be locally contained. In order to ‘contain and flush,’ appropriate sets of gas inlet valves, gas outlet valves, and in-line breaking valves can be used to close or open micro columns and fluid conduits. Such selection of certain valves can be addressed by electrostatic programmability to reduce the required number of control lines. Following containment of the un-separated samples from the ‘contain and flush’ process, the unseparated samples can be 2^{nd} order separated.

This multiple order separation in the circulatory GC can be repeated as many times as needed, such as 3^{rd}, 4^{th}, 5^{th}, and higher order separation in order to allow for complete or near complete separation. Accordingly, over-run can be avoided while providing an ultra-high separation capability by magnifying some closely located samples. This technique has an implication for highly non-distinguishable compound separation and can be directly applied to liquid domain and liquid chromatography.

### EXAMPLES

The following examples illustrate the embodiments of the disclosure that are presently best known. However, it is to be understood that the following are only exemplary or illustrative of the application of the principles of the present disclosure. Numerous modifications and alternative compositions, methods, and systems may be devised by those skilled in the art without departing from the spirit and scope of the present disclosure. The appended claims are intended to cover such modifications and arrangements. Thus, while the present disclosure has been described above with particularity, the following examples provide further detail in connection with what are presently deemed to be the most practical embodiments of the disclosure.

### Example 1: Micro Column Fabrication

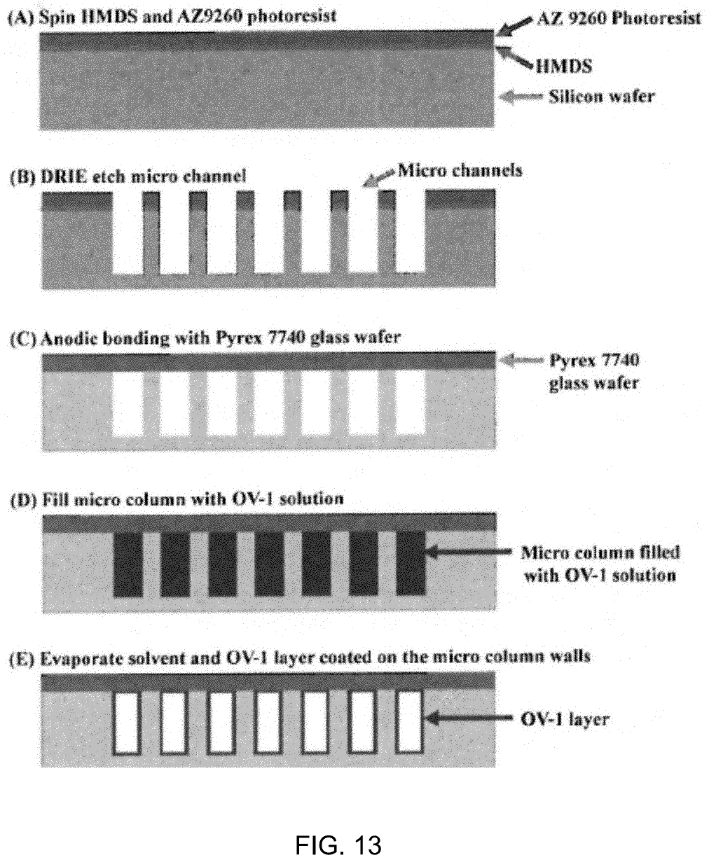

Micro columns were fabricated on a 4-inch (100 mm diameter) silicon wafer by etching a complete micro channel from the inlet to the outlet and bonding a glass wafer on top to close the channel, as illustrated in FIG. 13. To pattern and etch the micro channel, the silicon wafer was first coated with hexamethyl-disilazane (HMDS) to increase the adhesion between the wafer and the 14 μm thick AZ 9260 photoresist (A). The patterned wafers were deep reactive ion etched (DRIE) using an Oxford 100 ICP etcher (Oxford Instruments, UK), forming a high-aspect ratio (150/350 μm in width and depth) micro channel structure (B). To bond a glass wafer on top of the fabricated micro channel structure, the wafer was cleaned with oxygen plasma to remove the remaining polymer, then piranha solution (1:3 mixture of 30% H₂O₂ and 98% H₂SO₄). Next, the wafer was anodic-bonded to Pyrex 7740 glass wafer at a temperature of 350° C. and an applied voltage of 1000 V in the 520 IS bonding machine (EVG Group, Australia) (C). Also shown in D and E of FIG. 13 is the application of a stationary phase coating (see Ex. 2 below).

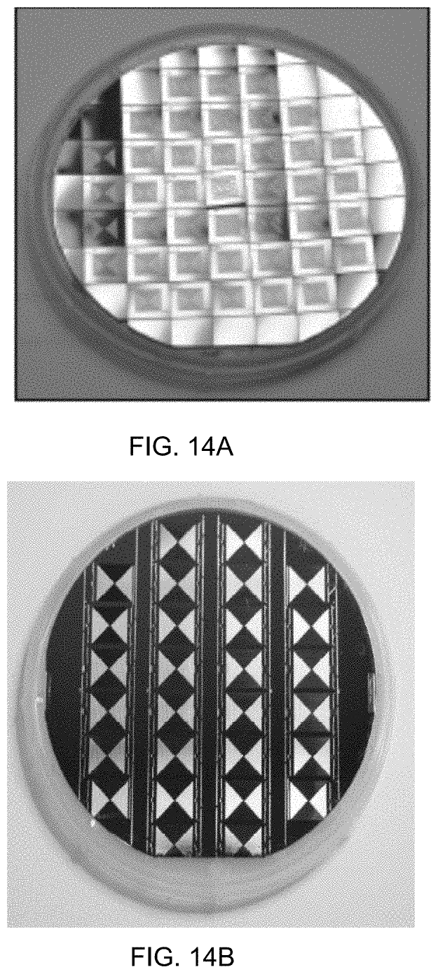

Following formation, the bonded wafer was diced into individual micro columns with a footprint of 1.1×1.1 cm² (FIG. 14A) with DAD641 dicing machine (DISCO, Japan) and cleaned with Acetone/IPA to remove the debris produced during dicing. One 4-inch silicon wafer produced 41 micro columns with a footprint of 1.1×1.1 cm² (FIG. 14B). Each column was examined to confirm that there was no defect or leak between adjacent micro channels by measuring the fluidic resistance, the ratio between the fluid pressure and the flow rates. The fabricated micro column contained a 25 cm long spiral-shaped micro channel with a cross section of 150×370 μm. The inlet and outlet ports were 350 μm wide, 370 μm deep and 2 mm long; and connected to fused silica capillary tubing with an OD of 360 μm and an ID of 250 μm.

### Example 2: Stationary Phase Coating

In one example, fabricated micro columns were coated with stationary phase materials to enhance the separation of target molecules during their travel. As a stationary phase material, nonpolar OV-1 polymer (OHIO VALLEY) which was selected because it is capable of separating various pollutant targets from hydrocarbons to amine compounds. The OV-1 polymer gel was first dissolved with pentane solvent into a final concentration of 14.7 mg mL⁻¹, which resulted in a final film thickness of 0.8 The diluted OV-1 solution was filled into the micro channel with a 10 mL, 30 gauge syringe until the channel was completely filled with the solution (FIG. 14D). The inlet of the micro column was then sealed with a paraffin film, while the outlet was opened to atmosphere for drying process. The micro column was then placed in a vacuum oven at 60° C. for 24 hours to evaporate the pentane solvent and left the OV-1 stationary phase layer on the channel walls (FIG. 14E). The resultant stationary phase was thermally-stabilized by heating the micro column at a ramping rate of 5 DC min-I to 150° C. where solvents are completely vaporized from the PDMS polymers for 2 hours. Followed by cooling to the room temperature, the micro column was exposed to constant flow (1 mL/min) of nitrogen carrier gas to avoid the oxidation. The curing process was continued until the complete removal of solvent was confirmed via the reduction of organic gas peaks to the baseline in the FID detector.

### Example 3: Characterization of Individual Micro Columns

To evaluate and optimize the micro column performance, micro columns were coated with different OV-1 layer thicknesses and supplied with target samples at various flow rates, while being monitored of separation efficiency, represented by a theoretical plate number. First, six micro columns were respectively coated with OV-1 solution with various concentrations of 1.8, 4.6, 9.2, 18.4, 27.6, 36.8 mg mL⁻¹ to produce different coating thicknesses. The resultant thicknesses of the OV-1 stationary phase were measured as 0.1, 0.2, 0.4, 0.8, 1.1 and 1.5 respectively. Second, the micro columns were supplied with the testing sample solution that contained alkane mixtures of 100 μL decane (C₁₀H₂₂), 100 μL dodecane (C₁₂H₂₆), 100 μL tetradecane (C₁₄H₃₀) and 100 μL hexadecane (C₁₆H₃₄) in 600 μL hexane (C₆H₁₄) solvent (GC or HPLC grade from Sigma-Aldrich). The sample was injected in a volume of 0.1 μL, which was precisely controlled by utilizing an AS3000 autosampler. Third, the flow rates of the sample were varied to cover a wide range of operation flow rates including 0.1, 0.2, 0.4, 0.8 and 1.0 mL min′. During the sample flow, the micro column was heated from 40° C. to 150° C. at a ramping rate of 40° C. min′. Finally, the resultant peaks, which represent each chemical compound, were evaluated by calculating the theoretical plate number following the widely-accepted plate number equation:

$$N = 16 {( \frac{{t}_{R}}{W} )}^{2}$$

where t_{R} was the measured peak retention time, W was the measured peak width in the time domain. Specifically, the peak of hexadecane was selected to calculate the plate number. Table 1 summarizes the results of the theoretical plate numbers vs. flow rates and stationary phase thicknesses, indicating the optimal conditions for the subsequent testing. The fabricated micro column produced the highest theoretical plate number, thus the best performance, of 12,720 with the OV-1 stationary phase thickness of 0.8 μm in all flow rates. Thus, the stationary phase thickness of 0.8 μm was chosen for the subsequent experiments. Note that the represented thickness was the average of three locations (front, middle and end) of the spiral micro channel. It is assumed that such differences could stem from variations in evaporation rates at each site that experienced different lengths of an evaporation path. The micro column also produced higher theoretical plate numbers at lower flow rates, determining the flow rate at 0.1 sccm, which is the lowest limit in the utilized GC system, in the subsequent testing.

TABLE 1
Theoretical plate number vs. flow rate
and stationary phase thickness

| | OV-1 Stationary Phase Thickness (μm) | | | | | |
|---|---|---|---|---|---|---|
| Flow | | | | | | |
| rate | | | | | | |
| (sccm) | 0.1 | 0.2 | 0.4 | 0.8 | 1.1 | 1.5 |
| 0.1 | 2315 | 526 | 3740 | 12720 | 1273 | 5048 |
| 0.2 | 1897 | 1510 | 4833 | 7911 | 1302 | 2393 |
| 0.4 | 630 | 639 | 2041 | 4436 | 704 | 1572 |
| 0.8 | 395 | 531 | 1285 | 2276 | 344 | 666 |
| 1.0 | 405 | 299 | 1115 | 1626 | 373 | 624 |

### Example 4: Separation of Pentane and Hexane

First, to evaluate the band-broadening effects and predict the maximum number of circulation cycle feasible, pentane gas was pumped into the cycle and monitoring was performed at every half cycle of circulation. The injected gas was split induced into the circulatory loop with a split ratio of 1:140 using a commercial Focus GC (Thermo scientific) with a nitrogen carrier gas at a flow rate of 0.5 mL per min′. Valve sequences were controlled by custom-program Aurino software in order to progress the pentane sample along the circulatory loop. During circulation, the loop was heated to and maintained at 40° C. The maximum number of circulation cycles was determined to be 16 cycles which corresponds to an effective column length of 8 m. The maximum cycles were limited due to degradation output signal strength. During cycling, the peak signal intensity decreased from 14.122 mV to 9305 mV after 3.5 cycles, then to 401 mV after 9 cycles and finally to 6 mV after 16 cycles. It was theorized that the cycling caused target volume loss per cycle due to non-ideal valve control.

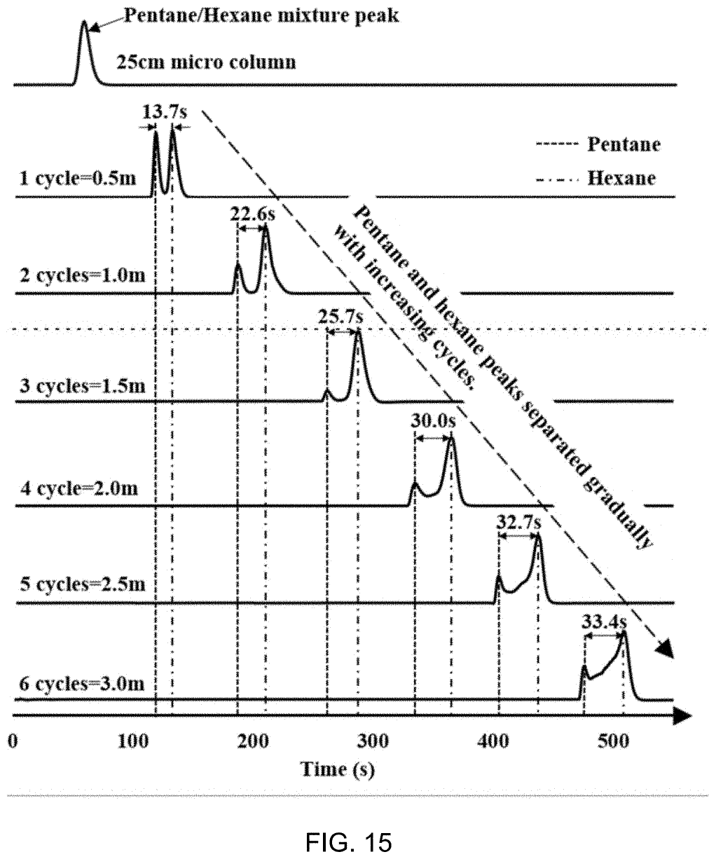

To demonstrate the enhancement and separation capability of the GC system, a pentane and hexane mixture was added to the system. Pentane and hexane were chosen because they are both alkanes with similar polarity indices of 0.0 and 0.1. FIG. 15 shows the successful separation process of a mixture of pentane and hexane gases into individual components during cyclic operation. After 0.5 cycle, equivalent to 25 cm column length, the mixture of pentane and hexane in circulation was not initially separated and could not be distinguished. The 0.5 cycle corresponds to the linear GC system with a 25-cm micro column, indicating that the mixture could not be identified with a conventional 25-cm linear GC system. After 1.0 cycle, equal to a 50-cm micro column, the mixture was isolated into two peaks with some portions of the two peaks being still connected.

In the two isolated peak, the pentane gas peak was the leading peak in the mixture and maintained inside the loop by switching the inlet, outlet, and in-line blocking valves before the gas peak eluted out through the outlets. In the 1.0 cycle of circulation separation, there was no switch; in the 2.0 cycles, there were two switches at 116 and 150 seconds to avoid the gases eluted out through the outlets. The same strategy was applied in the following cycles until the separation circulation reached 6 cycles, equal to a 3-meter linear column. Between 1.0 and 6.0 cycles, the mixture under circulation finally was clearly separated from each other forming two distinctive peaks. The R₂ values were 0.9999 and 0.9997 for the pentane and hexane. The first peak represented the pentane and the second peak corresponded to the hexane. The separation distance between the two peaks was further magnified from 13.7 seconds to 33.4 seconds as the circulation cycle increased from 1 to 6 cycles.

### Example 5: Fabrication of a Coil Shaped Thermal Conductivity Detector

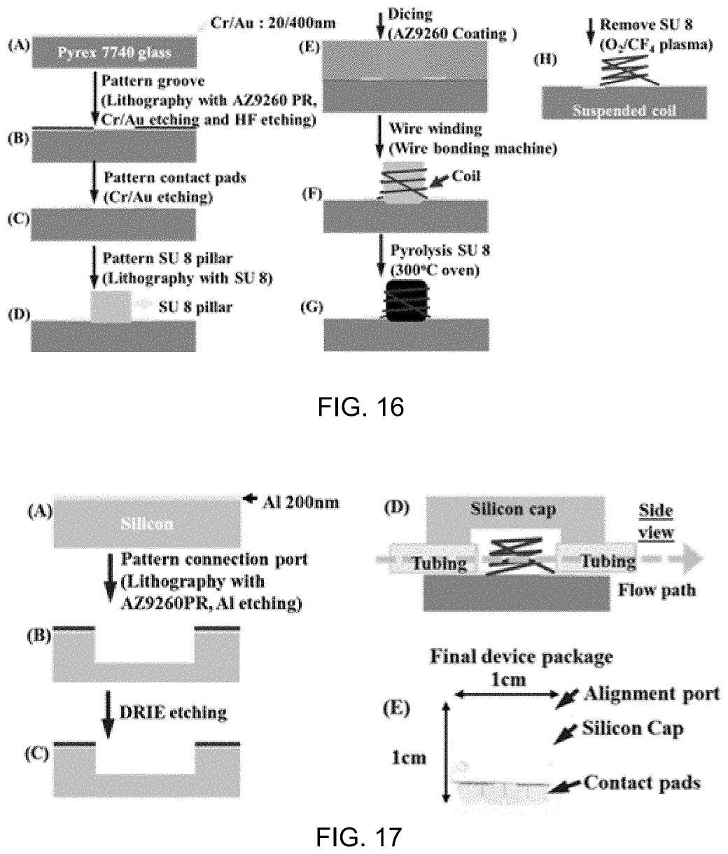

The structure of the coil-shape thermal conductivity detector consisting of sensing element, electrode contact pads, fluidic chamber lid and fluidic connection port was created as shown in FIG. 16. First, a layer of Cr/Au (20/400 nm) was sputter on the 4-inch Pyrex 7740 glass wafer. The wafer was then coated with a layer of 14-μm thick AZ 9260 photoresist. The cured photoresist was UV-exposed, and developed to produce the pattern of the electrode contact pads. The patterned wafer was then etched with chromium and gold etchant to form the electrode contact pads. The wafer was spin-coated for a second time with a thick layer of SU-8 2075 negative photoresist and patterned to form a pillar with a diameter of 200˜400 μm, and a height of 200 μm. The wafer with electrode contact pads and SU-8 pillars was covered with AZ9260 photoresist then diced into individual dices for wire-winding process. To form the coil shape, a wire bonding machine and aluminum bonding wire with a diameter of 25 μm was used. The aluminum wire was first bonded to one side of the contact pad and then winding around the SU-8 pillar for up to 4 turns, then attached to the other contact pads forming a suspended coil. The SU-8 pillar was removed from the suspended coil, first by pyrolysis process in a 300° C. oven for 3 hours and then O₂/CF₄ plasma etching.

The structure of the fluidic lid was created as shown in FIG. 17. First, a silicon wafer was sputter with 400 nm of aluminum layer and then spin-coated with 14-μm thick AZ 9260 photoresist. The photoresist was UV-exposed, and developed to produce a fluidic chamber and connection port pattern. The patterned wafer was etched utilizing deep reactive ion etching (DRIE) technique by utilizing an Oxford 100 ICP etcher (Oxford Instruments, UK). After DRIE process, an aluminum mask was etched with aluminum etchant and clean with DI water. The silicon lid and suspended coil part (from above; FIG. 16) were packaged by an anodic silicon-glass bonding in an EVG 520 IS bonding machine (EVG Group, Australia). During bonding, a temperature was 350° C. and a voltage of 1,000 V was applied. Inlet and outlet ports were connected to fused silica capillary tubing with an OD of 360 μm and ID of 250 μm. The resultant coil-shape TCD package had a dimension of 1 cm×1 cm×1.2 mm.

### Example 6: Fabrication of a Sensor-Embedded Micro Column

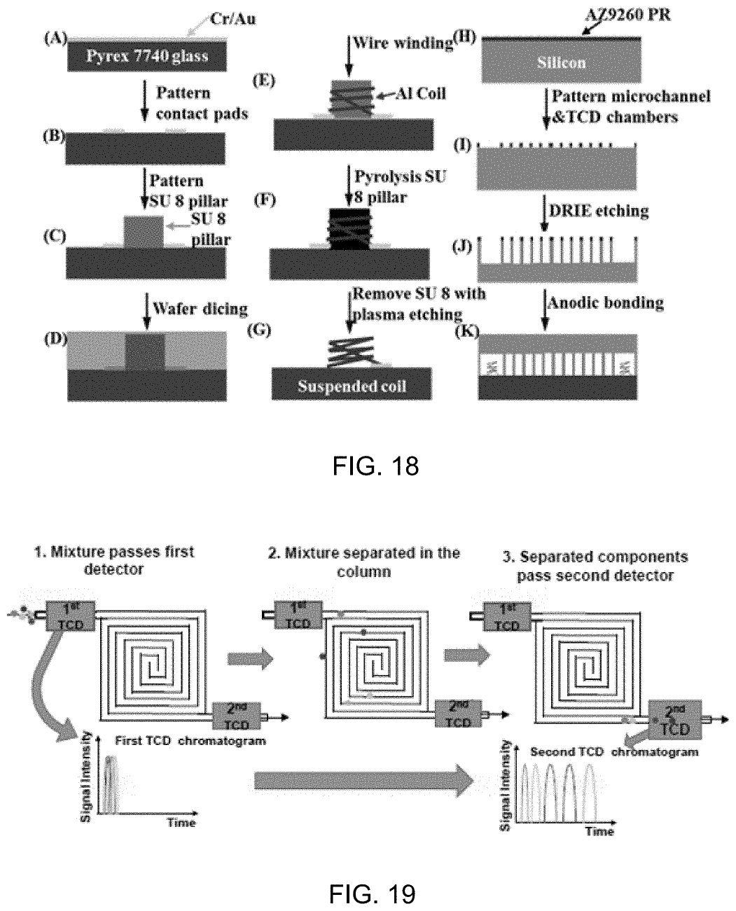

The Fabrication process of the sensor-embedded column, as shown in FIG. 18, was divided into two parts. The first part consisted of two coil sensing elements and four electrode contact pads. The second part consisted of two fluidic chambers to containing the coil sensing elements and two fluidic connection ports, between a 25-cm long channel as the micro column.

To fabricated the first layer, a layer of Cr/Au (20/400 nm) was sputter on the 4-inch Pyrex 7740 glass wafer. The wafer was then coated with a layer of 14-μm thick AZ 9260 photoresist. The cured photoresist was UV-exposed, and developed to produce the pattern of the electrode contact pads. The patterned wafer was then etched with chromium and gold etchant to form the electrode contact pads. The wafer was further spin-coated with a thick layer of SU-8 2075 negative photoresist and patterned to form a pillar with a diameter of 200˜400 μm and a height of 200 μm. The wafer with electrode contact pads and SU-8 pillars was covered with AZ9260 photoresist then diced into individual dices for wire-winding process. To form the coil shape, a wire bonding machine and aluminum bonding wire with a diameter of 25 μm was used. The aluminum wire was first bonded to one side of the contact pad and then winding around the SU-8 pillar for up to 4 turns, then attached to the other contact pads forming a suspended coil. The SU-8 pillar was removed from the suspended coil, first by pyrolysis process in a 300° C. oven for 3 hours and then O₂/CF₄ plasma etching.

To fabricate the second layer, a silicon wafer was spin-coated with 14-μm thick AZ 9260 photoresist. The photoresist was UV-exposed, and developed to produce the fluidic chambers and connection ports and 25-cm long micro channel pattern. The patterned wafer was etched utilizing deep reactive ion etching (DRIE) technique by utilizing an Oxford 100 ICP etcher (Oxford Instruments, UK). The first micro channel part and second coil sensor part were packaged via anodic silicon-glass bonding at a temperature of 350° C. and an applied voltage of 1,000 V in the EVG 520 IS bonding machine (EVG Group, Australia). The inlet and outlet ports were connected to fused silica capillary tubing with an OD of 360 μm and ID of 250 μm. The final package has a dimension of 20 mm×12 mm×1.2 mm.

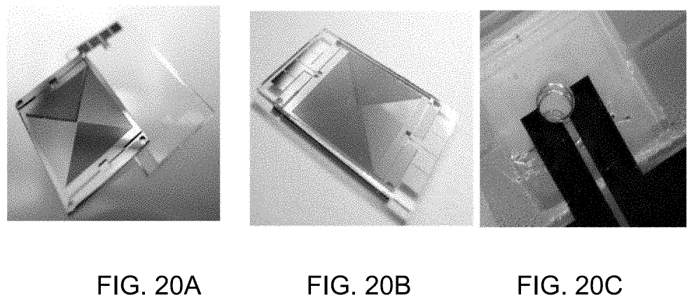

An integrated micro column having an in-line population senor as created above, can allow for multiple readings to occur of the sample as it enters and exits the micro column as schematically shown in FIG. 19. FIGS. 20A-20C are images of an integrated micro column created using the methods described above.

The described features, structures, or characteristics may be combined in any suitable manner in one or more examples. In the preceding description numerous specific details were provided, such as examples of various configurations to provide a thorough understanding of examples of the described technology. One skilled in the relevant art will recognize, however, that the technology may be practiced without one or more of the specific details, or with other methods, components, devices, etc. In other instances, well-known structures or operations are not shown or described in detail to avoid obscuring aspects of the technology.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

What is claimed is:

1. A gas chromatography system comprising:
a recirculating loop;
a gas inlet positioned along the recirculating loop and configured to admit gas into the recirculating loop;
a gas inlet valve associated with the gas inlet, wherein the gas inlet valve can be switched to allow gas to flow into the recirculating loop;
a gas outlet positioned along the recirculating loop and configured to withdraw gas from the recirculating loop;
a gas outlet valve associated with the gas outlet, wherein the gas outlet valve can be switched to allow gas to flow out of the recirculating loop;
a micro column positioned in line with the recirculating loop such that gas cycles around the recirculating loop and through the micro column multiple times; and
an in-line population sensor positioned in line with the recirculating loop, the in-line population sensor configured to detect changes in gas population.

2. The gas chromatography system of claim 1, further comprising an in-line micro pump configured to recirculate gas in the recirculating loop.

3. The gas chromatography system of claim 1, further comprising an in-line blocking valve and a controller, wherein the controller is configured to open and close the gas inlet valves, the gas outlet valves, and the in-line blocking valves in a sequence to recirculate gas in the recirculating loop.

4. The gas chromatography system of claim 3, wherein the system comprises two gas inlets, two gas outlets, two in-line blocking valves, and two micro columns positioned along the recirculating loop in the order of: gas inlet; in-line blocking valve; gas outlet; micro column; gas inlet; in-line blocking valve; gas outlet; micro column.

5. The gas chromatography system of claim 4, wherein the system comprises in-line population sensors positioned immediately before or immediately after each micro column.

6. The gas chromatography system of claim 1, further comprising a controller in communication with the in-line population sensor and the gas outlet valve, the controller configured to open the gas outlet valve to withdraw a detected peak from the recirculating loop to prevent overrun and to enable magnification.

7. The gas chromatography system of claim 1, wherein the micro column has a column length of at least 20 cm occupying an area of 2 cm² or less.

8. The gas chromatography system of claim 1, wherein the in-line population sensor is a thermal conductivity sensor, an optical sensor, or an electrochemical sensor.

9. The gas chromatography system of claim 9, wherein the thermal conductivity sensor has a suspended coil shape.

10. The gas chromatography system of claim 9, wherein the thermal conductivity sensor comprises a suspended sensing element, an electric contact pad, a fluidic connection port, and a fluidic chamber lid; wherein the suspended sensing element is connected at one end to the electric contact pad and connected at a second end to a second electric contact pad; wherein the fluidic connection port is adjacent to the electric contact pad and a second fluidic connection port is adjacent to the second electric contact pad and wherein the fluidic chamber lid can is adjacent to each of the fluidic connection ports and encloses the suspended sensing element.

11. The gas chromatography system of claim 1, wherein the in-line population sensor is located at an inlet and of the micro column and a second in-line population sensor is located at an outlet of the micro column.

12. The gas chromatography system of claim 1, wherein the in-line population sensor is further operable to send feedback signals to a sensor-feedback control program operable to control fluidic flow rates and monitor separation progress.

13. The gas chromatography system of claim 1, further comprising a valve switching control unit in operative communication with at least one of the gas inlet valve, the gas outlet valve, and in line blocking valves, when the system further comprises the in line blocking valves.

14. The gas chromatography system of claim 1, wherein the micro column comprises a separation enhancing coating on an interior surface of the micro column.

15. The gas chromatography system of claim 1, wherein the micro column comprises an embedded sensor.

16. The gas chromatography system of claim 1, wherein the micro column comprises an inlet and an outlet connected by a pathway, wherein the pathway is in the shape of a double spiral.

17. The gas chromatography system of claim 1, wherein the micro column comprises an inlet and an outlet connected by a pathway, wherein the pathway has a serpentine shape.

18. The gas chromatography system of claim 1, wherein the gas admitted into the recirculating loop by the gas inlet includes pressurized carrier gas.

19. The method of claim 18, wherein the recirculating is performed without the use of a micropump and the recirculating is driven by pressurized carrier gas.

20. A method of separating a gas sample through gas chromatography, comprising:
admitting a gas sample into a recirculating loop of a gas chromatography system, wherein the system comprises:
the recirculating loop;
a gas inlet positioned along the recirculating loop and configured to admit gas into the recirculating loop;
a gas inlet valve associated with the gas inlet, wherein the gas inlet valve can be switched to allow gas to flow into the recirculating loop;
a gas outlet positioned along the recirculating loop and configured to withdraw gas from the recirculating loop;
a gas outlet valve associated with the gas outlet, wherein the gas outlet valve can be switched to allow gas to flow out of the recirculating loop;
a micro column positioned in line with the recirculating loop; and
an in-line population sensor positioned in line with the recirculating loop, the in-line population sensor configured to detect changes in gas population;
recirculating the gas sample through the recirculating loop for more than one cycle such that the gas sample passes through the micro column multiple times; and
detecting at least one component of the gas sample using the in-line population sensor.
